(19) United States
(12) Patent Application Publication
(10) Pub. No.: US 2025/0124409 A1
(43) Pub. Date: Apr. 17, 2025

(54) Personalized Event Consolidation Bot

(71) Applicant: International Business Machines Corporation, Armonk, NY (US)

(72) Inventors: Peng Hui Jiang, Beijing (CN); Su Liu, Austin, TX (US); Richard Anthony LaFrance, Grosse Ile, MI (US); Guang Han Sui, Beijing (CN)

(21) Appl. No.: 18/378,879

(22) Filed: Oct. 11, 2023

(51) Int. Cl. G06Q 10/1093

(52) U.S. Cl. CPC G06Q 10/1093

(57) ABSTRACT

Mechanisms are provided to consolidate event data structures in an electronic calendar. An event data structure for an event is received and features are extracted from the event data structure and another having an overlapping temporal location in the electronic calendar. The event data structure is classified as to whether it is duplicative of the other event data structure and the event data structures are rendered based on the classification. This rendering may involve consolidating the event data structures into a consolidated event data structure if they are duplicative, and prioritizing the event data structures relative to each other if they are not duplicative.

### BACKGROUND

The present application relates generally to an improved data processing apparatus and method and more specifically to an improved computing tool and improved computing tool operations/functionality for providing a personalized event consolidation bot (PECB) for seamless event integration events and efficient planning and execution.

Event management often requires management of multiple different calendars, which may include both physical and electronic calendars. The management of multiple calendars involves manually cross-referencing schedules and manually resolving conflicts, which is a time consuming process and prone to errors due to the limitations of human mental capabilities. That is, it is difficult for a person to maintain in their mind, with any sense of order and arrangement, the various events and information for each of the events, and the like, especially when such events and information may be maintained in different sources, e.g., different calendars, and the different calendars may not store the same events. Often information will be missed, conflicts between events represented in different calendars will not be identified, differences and/or conflicts in the event information about events may not be readily identified and resolved, etc., even if a person attempts to perform manual cross-referencing and manual conflict resolution.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided for consolidation event data structures in an electronic calendar. The method comprises receiving an event data structure for an event from an event resource and extracting features from the event data structure and at least one other event data structure having an overlapping temporal location in the electronic calendar. The method further comprises executing at least one first machine learning computer model on the extracted features to classify the event data structure as to whether the event data structure is duplicative of the at least one other event data structure. In addition, the method comprises rendering, in the electronic calendar, at least one consolidated event data structure corresponding to the event data structure and the at least one other event data structure based on the classification of the event data structure. Rendering the at least one consolidated event data structure comprises, in response to the classification indicating that the event data structure is duplicative of the at least one other event data structure, merging the event data structure with the at least one other event data structure to generate the at least one consolidated event data structure.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of an electronic calendar display illustrating the representation of duplicate and conflicting events;

FIG. 2 is an example diagram of a distributed data processing system environment in which aspects of the illustrative embodiments may be implemented and at least some of the computer code involved in performing the inventive methods may be executed;

FIG. 3 is an example block diagram illustrating the primary operational components of a personalized event consolidation bot (PECB) framework in accordance with one illustrative embodiment;

FIG. 4 is an example flow diagram illustrating the operation and interaction of the components of the PECB framework in accordance with one illustrative embodiment;

FIG. 5 is an example diagram of event data structures in which duplicate events are present and a corresponding merged event data structure in accordance with one illustrative embodiment;

FIG. 6 is an example diagram of event data structures in which conflicting events are present and a prioritized event list layout in accordance with one illustrative embodiment; and

FIG. 7 is a flowchart outlining an overall operation of a personalized event consolidation bot in accordance with one illustrative embodiment.

### DETAILED DESCRIPTION

The illustrative embodiments provide an improved computing tool and improved computing tool operations/functionality for providing a personalized event consolidation bot (PECB) for seamless event integration and efficient planning and execution. The “bot” in the illustrative embodiments is an artificial intelligence (AI) computing tool that automatically operates on event data structures that may be present in the same or different event information data sources, e.g., electronic calendars and the like, and applies AI computer models to the event data structures to perform event consolidation which includes event cross-referencing, event conflict resolution, and other event management operations, as described in more detail hereafter.

The following description provides examples of embodiments of the present disclosure, and variations and substitutions may be made in other embodiments. Several examples will now be provided to further clarify various aspects of the present disclosure.
Example 1: A method, in a data processing system, for consolidating event data structures in an electronic calendar is provided. The method comprises receiving an event data structure for an event from an event resource. The method also comprises extracting features from the event data structure and at least one other event data structure having an overlapping temporal location in the electronic calendar. The method further comprises executing at least one first machine learning computer model on the extracted features to classify the event data structure as to whether the event data structure is duplicative of the at least one other event data structure. In addition, the method comprises rendering, in the electronic calendar, at least one consolidated event data structure corresponding to the event data structure and the at least one other event data structure based on the classification of the event data structure. The method may also comprise rendering the at least one consolidated event data structure comprises, in response to the classification indicating that the event data structure is duplicative of the at least one other event data structure, merging the event data structure with the at least one other event data structure to generate the at least one consolidated event data structure.

The above limitations advantageously enable consolidation of event data structures that may be duplicative of one another or conflicting which allows for integration of event data structures from a variety of different event data sources minimal duplicative or conflicting representations in the graphical user interface output, such as in electronic calendar outputs. The resulting graphical user interface outputs have fewer confusing elements making the graphical user interface more user friendly.
Example 2: The limitations of any of Examples 1 and 3-16, where rendering the at least one consolidated event data structure comprises, in response to the classification indicating that the event data structure is not duplicative of the at least one other event data structure, generating a relative priority scoring of the event data structure relative to the at least one other event data structure and rendering the at least one consolidated event data structure as a relative rendering of the event data structure and the at least one other event data structure that depicts the relative priority scores. The above limitations advantageously provide automated prioritization of conflicting event data structures relative to one another to aid the user in determining which conflicting events the user may wish to focus their attention on. This allows the user to determine, in cases where the user is unable to attend or engage in each of the conflicting events, which events are most important for the user to consider.
Example 3: The limitations of any of Examples 1-2 and 4-16, where generating a relative priority scoring of the event data structure comprises executing at least one second machine learning computer model on the extracted features to generate a priority score for the event data structure and the at least one other event data structure. The above limitations advantageously provide an automated intelligent determination of priorities of events when the events are conflicting with one another based on machine learning of features indicative of priority. The automated determination of priorities alleviates users having to investigate the details of each conflicting event data structure to determine which events should have priority over others. The automated machine learning computer models aids users by providing recommendations as to the priorities that the user should apply to each of the conflicting event data structures.
Example 4: The limitations of any of Examples 1-3 and 5-16, where the at least one second machine learning computer model comprises a second machine learning computer model that determines a purpose of the event data structure and a purpose of the at least one other event data structure based on the extracted features, and wherein the relative priority scores are based on the determined purpose of the event data structure and purpose of the at least one other event data structure. The above limitations advantageously can automatically and intelligently determine priorities of conflicting event data structures based on the purposes of the events. This aids users in determining what event data structures correspond to events that provide the highest impact on the purposes important to the user.
Example 5: The limitations of any of Examples 1-4 and 6-16, where the method further comprises retrieving a user profile for a user associated with the electronic calendar and where the user profile specifies one or more event resources, from a plurality of event resources, to consolidate and one or more types of event data structures to consolidate. In addition, the method further comprises determining whether the event data structure for the event is from an event resource that matches the one or more event resources specified in the user profile. In response to the event data structure being received from an event resource matching the one or more event resources, determining whether a type of the event data structure matches the one or more types of event data structures to consolidate as specified in the user profile. In response to the type of the event data structure matching the one or more types of event data structures to consolidate, performing the executing and rendering operations.

The above limitations advantageously provide mechanisms by which users may specify the sources of event data structures and the types of events that the user wishes to have consolidated. Thus, a selective consolidation of event data structures is facilitated. Hence, a user may specify particular event data structures sources that the user wishes to process with consolidation of the event data structures when the event data structures are determined to be duplicative or conflicting with other event data structures. Moreover, the user may specify which types of events should have their event data structures processed for consolidation by integrating duplicative event data structures and/or prioritizing conflicting event data structures.
Example 6: The limitations of any of Examples 1-5 and 7-16, where the method further comprises training, the at least one first machine learning computer model, on training data comprising existing samples of event data structures and ground truth classification of the existing samples. The training comprises, for each sample in the training data: processing the sample in the training data to generate a classification result specifying whether the sample represents duplicate event data structures or conflicting data structures; comparing the classification result to the corresponding ground truth classification to determine a loss; and modifying an operational parameter of the at least one first machine learning computer model based on the determined loss. The above limitations advantageously provide automated computer intelligence that is specifically trained through machine learning processes on specific event data structure samples to learn patterns of event data structure features that are indicative of particular types of classifications, and specifically whether event data structures are duplicative of one another or are conflicting event data structures. In this way, an automated classification of event data structures by specific machine learning is made possible.
Example 7: The limitations of any of Examples 1-6 and 8-16, where the samples are captured instances of previous manual consolidations of event data structures by a user associated with the electronic calendar. The above limitation advantageously can perform machine learning training based on actual user inputs to consolidate event data structures, and thus, the machine learning is customized or specific to the particular user. That is, the samples upon which the machine learning training is performed reflects the specific user's classification of event data structures and their corresponding consolidation operations. This information is used as training data such that the resulting machine learning computer model(s) reflect the user's classification and resulting consolidation operations.
Example 8: The limitations of any of Examples 1-7 and 9-16, where the method further comprises receiving a user input to a user interface associated with the electronic calendar, wherein the user input specifies an acceptance or rejection of the at least one consolidated event data structure, and dynamically updating an operational parameter of the at least one first machine learning computer model based on the user input specifying acceptance or rejection of the at least one consolidated event data structure. The above limitations advantageously enable dynamic machine learning of the computer models as the user provides feedback via the user interface as to the correctness or incorrectness of the results generated by the trained machine learning computer models. That is, the user's acceptance of the at least one consolidated event data structure is indicative of the correctness of the training of the machine learning computer model, whereas the rejection of the at least one consolidated event data structure is indicative of an incorrect result of the machine learning computer model. This feedback may be used to adjust operational parameters, such as weights of nodes in the machine learning computer model, for example. The weights may be adjusted with regard to nodes that provide a greatest influence on the final result of the machine learning computer model, or may be adjusted through other machine learning training operations, such as linear regression or the like.
Example 9: The limitations of any of Examples 1-8 and 10-16, where the method is executed in response to receiving a user input to a human-computer interaction (HCI) environment of the data processing system, and executing natural language processing on the user input, where the natural language processing determines an intent of the user input as being associated with event consolidation. The above limitations advantageously allow users to interact with HCI environments using natural language inputs and the mechanisms of the illustrative embodiments may operate on these user inputs to determine whether to consolidate event data structures. Thus, the mechanisms of the illustrative embodiments are configured to operate in conjunction with natural language processing mechanisms of HCI environments which are more user friendly and natural to user interactions.
Example 10: The limitations of any of Examples 1-9 and 11-16 where the HCI environment is a chatbot application and the user input is a natural language statement entered into the chatbot application, and wherein rendering at least one consolidated event data structure further comprising outputting a natural language response to the user input via the chatbot application. The above limitations advantageously allow the mechanisms of the illustrative embodiments to be integrated with natural language based user interfaces, such as those of a chatbot or the like, with natural language responses being provided to the user. This helps to improve the human-computer interaction with the user and makes the user experience more friendly to the user.
Example 11: The limitations of any of Examples 1-10 and 12-16 where the extracted features comprise an event title, an event date, an event time, an event location, and event participants. The above limitations advantageously allow for the determination of whether an event data structure is a duplicate of another event data structure or a conflicting event data structure based on specific elements of the event data structure, namely the event title, the event date, event time, event location, and event participants. These elements are highly indicative of whether an event data structure is duplicative or conflicting. However, the evaluation allows for differences in these features but still a determination that the event data structures are duplicative in cases where the differences are not significant enough to indicate the event data structures to be directed to different events.
Example 12: The limitations of any of Examples 1-11 and 13-16 where merging the event data structure with the at least one other event data structure comprises executing consolidation strategy rules or algorithms that specify logic for combining event descriptions, merging participant lists, and updating event properties to accommodate the properties of the event data structure and the at least one other event data structure. The above limitations advantageously allow for specifying different types of consolidation strategies for performing specific types of consolidations of event data structures based on determinations of event data structure duplicates and/or conflicting event data structures.
Example 13: The limitations of any of Examples 1-12 and 14-16 where merging the event data structure with the at least one other event data structure comprises executing consolidation strategy rules or algorithms that specify logic for resolving conflicting properties of the event data structure and the at least one other event data structure. The above limitations advantageously allow consolidation strategy rules or algorithms to be defined and executed based on the classification of event data structures as to whether they are duplicative or conflicting. The consolidation strategy rules or algorithms may be executed to automatically perform specific merging operations taking into consideration differences in the data of the event data structures such that information in differing event data structures is not lost as a result of the merging.
Example 14: The limitations of any of Examples 1-13 and 15-16 where generating the relative priority scoring of the event data structure comprises applying one or more user specified prioritization criteria specified in a user profile of a user associated with the electronic calendar. The above limitation allows the user to customize the way in which conflicting event data structures are prioritized relative to one another. In which way, the user may specify which types of events are of more importance to the user, with these customizations being automatically applied by the mechanisms of the illustrative embodiments when prioritizing event data structures relative to one another.
Example 15: The limitations of any of Examples 1-14 and 16 where the one or more user specified prioritization criteria comprises at least one executable rule specifying a condition and a modification of a priority score of a corresponding event data structure in response to the condition being satisfied, and wherein the condition is based on event participant acceptance of an invitation associated with the corresponding event data structure. The above limitations advantageously allow the user to specify how to modify the priorities of event data structures based on other participant responses to invitations to the event. That is, if an event is not being positively responded to by other participants, the event may be of less priority to the user than other events that have relatively higher participant positive response. Thus, prioritization may be initially made based on various properties of the event data structures, and then may be modified based on participant response to invitations to the event, thereby dynamically updating the priority of the event data structures.
Example 16: The limitations of any of Examples 1-15 where rendering the at least one consolidated event data structure further comprises generating a reminder or notification for the at least one consolidated event data structure based on reminder or notification settings associated with the event data structure and the at least one other event data structure. The above limitation advantageously allows for notifications to be generated for the consolidated event data structures based on the notifications that were associated with the event data structures that were consolidated. In this way, the specifics of the notifications for each of the event data structures may be reflected in the notification associated with the consolidated event data structure.
Example 17: A computer program product comprising a computer readable storage medium having a computer readable program stored therein, wherein the computer readable program, when executed on a computing device, causes the computing device to implement the method according to any one of Examples 1-16. The above limitations advantageously enable a computer program product having program instructions configured to cause one or more processors to perform and realize the advantages described with respect to Examples 1-16.
Example 18: An apparatus comprising at least one processor and at least one memory coupled to the at least one processor, wherein the at least one memory comprises instructions which, when executed by the at least one processor, cause the at least one processor to implement the method according to any one of Examples 1-16. The above limitations advantageously enable an apparatus comprising one or more processors to perform and realize the advantages described with respect to Examples 1-16.
Example 19: A method, in a data processing system, for consolidating event data structures in an electronic calendar is provided. The method comprises receiving an event data structure for an event from an event resource. The method also comprises extracting features from the event data structure and at least one other event data structure having an overlapping temporal location in the electronic calendar. The method further comprises executing at least one first machine learning computer model on the extracted features to classify the event data structure as to whether the event data structure is duplicative of the at least one other event data structure. In addition, the method comprises rendering, in the electronic calendar, at least one consolidated event data structure corresponding to the event data structure and the at least one other event data structure based on the classification of the event data structure. The method may also comprise rendering the at least one consolidated event data structure comprises, in response to the classification indicating that the event data structure is duplicative of the at least one other event data structure, merging the event data structure with the at least one other event data structure to generate the at least one consolidated event data structure. Rendering the at least one consolidated event data structure comprises, in response to the classification indicating that the event data structure is not duplicative of the at least one other event data structure, generating a relative priority scoring of the event data structure relative to the at least one other event data structure and rendering the at least one consolidated event data structure as a relative rendering of the event data structure and the at least one other event data structure that depicts the relative priority scores.

The above limitations advantageously realize the benefits described above with respect to Examples 1 and 2. The above limitations advantageously provide automated computer mechanisms that consolidate event data structures based on a classification of the event data structures being either duplicative of one another or conflicting with one another. In this way, the graphical user interface representations of event data structure from various event data structure sources may be presented with minimal duplication and conflict. This improves the usability of the graphical user interface and reduces manual efforts to try and resolve duplication and conflicts between event data structures from the various sources.

To illustrate the advantages of the various illustrative embodiments, it should be appreciated that it has been recognized that while electronic calendars have helped with organizing information about events, they have limited capabilities for event management in that they merely display information and do not have suitable intelligence for performing event management operations. Event management is a dynamic and multi-faceted field that involves planning, organizing, and executing various types of events. Event management encompasses a wide range of activities, from small social gatherings to large-scale conferences, festivals, weddings, corporate events, and the like. A goal of event management is to create memorable and successful experiences for attendees while achieving the objectives set by event organizers.

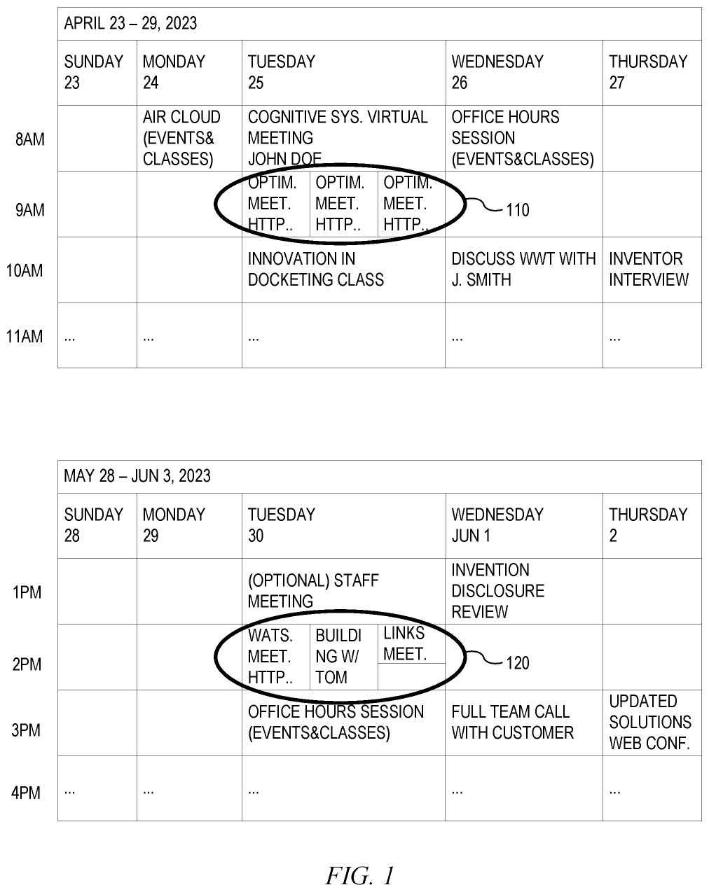

The practice of event management has evolved significantly over the years, influenced by societal changes, technological advancements, and the growing demand for professionally organized events. Event management presents unique challenges, such as budget constraints, logistical complexities, ensuring attendee satisfaction, risk management, and adapting to changing trends. In view of these challenges, various event management computer tools have been developed for assisting human beings in creating, managing, and tracking events using electronic calendar applications. These event management computer tools may offer capabilities for sending electronic invitations to event participants, may manage sending the invitations and handling responses to such invitations via electronic mail, may offer capabilities for displaying calendars electronically on computer displays with event information organized and represented in the electronic calendar display, and the like. In some cases, these event management computer tools may even be able to display such event information in a manner that can be used to identify potential conflicts between events (see FIG. 1 discussed herein below). However, these event management computing tools do not comprise the intelligence to resolve such conflicts or prioritize events for the particular user in an automated manner. Moreover, such event management computing tools do not comprise intelligence to resolve such conflicts from multiple different event information data sources and determine if and when to merge event entries.

For example, as shown in FIG. 1, electronic calendar applications, having event management tools, may allow multiple event entries in an electronic calendar for the same event, as shown in 110 of FIG. 1. For example, multiple parties may send calendar invitations through the electronic calendar application for the same event. Each of these will be displayed in a manner that they appear to conflict with one another, e.g., side-by-side at a same day/time. If a user manually deletes one of these duplicate entries in the electronic calendar, the deletion action may trigger a “rejection” response that is sent back to the user that sent the invitation to the event, erroneously indicating a rejection of the event itself. As a result, confusion may occur on the part of the recipient of the rejection response in that the recipient may understand the rejection response to be a rejection of the event, when in fact the user may be attending the event, but was merely deleting a duplicate entry in their electronic calendar.

In other instances, such as shown in 120 of FIG. 1, a user may receive invitations to events that are scheduled at the same, or an overlapping, day/time. Existing electronic calendar applications permit such events to be scheduled and represented in the electronic calendar display as shown in FIG. 1. In order to resolve this, a user would need to manually open each of the scheduled events and make determinations as to which event to attend. There is no ability in the existing art of electronic calendar applications to intelligently resolve conflicts in event entries, determine which events to prioritize, and determine which events to merge. Moreover, there is no ability in the existing art of electronic calendar applications to perform the subsequent actions to resolve these conflicts by removing/merging duplicate event entries, as well as communicate with sources of event data based on prioritization of conflicting events.

To address the limitations of existing electronic calendar applications and event management tools, the illustrative embodiments provide an improved computing tool and improved computing tool operations/functionality which includes a personalized event consolidation bot (PECB). The PECB comprises a computer framework, computer applications, data structures, and artificial intelligence (AI) computer models that are specifically configured and trained to perform operations that automate and streamline the process of consolidating events across multiple event information data sources, e.g., electronic calendars and the like. The PECB of the illustrative embodiments operates to proactively merge duplicative event data structures directed to the same event into a single event data structure, intelligently prioritize different events, which may be conflicting with one another, according to event data and personal needs/preferences of the user, and render event information in electronic calendar displays and event lists in accordance with the merging of event data structures and prioritization of events. The resulting electronic calendar and event lists may be interacted with by a user via a human-computer interface (HCI) environment and user feedback may be obtained through the HCI as to the correctness/incorrectness of the merging/prioritization so that the training of the AI computer models may be updated dynamically based on the user feedback.

The PECB of the illustrative embodiments provides computing tools and functionality for users to configure settings, such as which event information data sources to consolidate, what types of events to consolidate, event merge thresholds and criteria, settings for representing the event information in graphical representations, and settings for the event consolidation, merging, and prioritization. The PECB of the illustrative embodiments provides various configuration files and data structures for configuring the various computing tools of the PECB framework and for specifying computer executable rules for implementing some of the operations of the PECB. The PECB of the illustrative embodiments further includes one or more machine learning computer models, i.e., AI computer models, such as neural networks (e.g., convolutional neural networks (CNNs), deep learning neural networks (DNNs), and the like), random forest computer models, decision tree computer models, and the like, which are trained and operate on existing data samples, e.g., existing data samples of event data structures and the corresponding merged/prioritized action that is to be performed with those event data structures, to learn merging and prioritization of these data samples by users, and thereby learn how to predict or classify new data samples with regard to merging and prioritization.

The learning performed by the one or more machine learning computer models may be used to implement various consolidation and prioritization strategies when performing event consolidation operations. For example, the one or more machine learning computer models may operate on new event data structures to identify duplicate events based on similarities in features extracted from event data structures. The identification of the duplicate events may be used along with a set of consolidation algorithms to determine which event data structure instance to maintain, and which to remove/merge into the selected event data structure instance to thereby consolidate and de-duplicate the event data structures. The one or more machine learning computer models may further operate to identify conflicting event data structures and evaluate and classify the event data structures as to their event purpose. Again, these machine learning computer models may operate in conjunction with a set of prioritization algorithms that operate to prioritize conflicting event data structures with regard to their event purpose. These machine learning computer models may undergo an initial training based on training data comprising samples of event data structures and corresponding user specified consolidations/prioritizations of the event data structures. Thereafter, the training of the machine learning computer models may be updated dynamically based on user feedback as to the correctness/incorrectness and/or user specified overrides of automatically determined consolidation/prioritization results.

The PECB computing tool and PECB operations/functionality of the illustrative embodiments solves the issues associated with existing electronic calendar applications and their event management tools by providing an intelligent computing tool, implementing machine learning computer models and other computer intelligence, to automatically perform event consolidation and prioritization when presented with conflicting event data structures from the same or different event information data sources. The conflicting event data structures may be for the same event (duplicate event data structures) or different events (conflicting event data structures with regard to time and/or location). The PECB computing tool improves upon existing event management tools in that rather than being limited to merely displaying event information in calendar form and leaving it to a user to decide whether to investigate duplicate and/or conflicting events, the illustrative embodiments specifically perform automated machine learning and artificial intelligence based resolution of duplicate and/or conflicting events prior to presenting the rendering of event information to the user. Thus, no user intervention is required to perform the resolution of duplicate and/or conflicting events. While user feedback may, in some illustrative embodiments, be solicited in order to improve the machine learning training of the PECB computing tool, such user feedback is not required for operation of the PECB computing tool.

It should be appreciated that with the mechanisms of the illustrative embodiments, the event data structures that are the subject of the consolidation operations performed by the improved computing tool and improved computing tool functionality of the present invention, may be obtained from a plurality of different event resources or source applications/computing systems. Each of these event resources may have their own formatting of event data which may not be compatible with one another. This incompatibility of event data structures from one event resource to another makes it such that existing systems cannot readily determine whether an event from an event resource A is the same event as an event from an event resource B, or that event A conflicts with event B. That is, because the formatting and content of the event data structures may be varied and may not be consistent with one another, e.g., different calendar applications, for example, may use their own formats for various attributes of an event including date, time, title, description, and file extensions, existing systems are unable to discern which event data structures are directed to the same event or which event data structures represent potential conflicts, as each electronic calendar application and event management tool expects to see data structures formatted according to their specific coding. For example, with a date of an event, the date format may vary across calendar applications as different formats of MM/DD/YYYY (e.g., Dec. 31, 2023), DD/MM/YYYY (e.g., 31 Dec. 2023), YYYY/MM/DD (e.g., 2023 Dec. 31). The time format may vary as to whether a 12-hour clock or 24-hour clock is utilized, the level of precision in the clock that is utilized, and the like, e.g., 12-hour clock with AM/PM (e.g., 03:30 PM), 24-hour clock (e.g., 15:30), 24-hour clock that includes seconds (e.g., 15:30:45), etc. The length and formatting of titles may vary across calendar applications, the length and formatting of descriptions or body text may be different across calendar applications with some allowing rich text formatting, including lists, links and attachments, while others may require simple text descriptions. The location, available options, and formatting of metadata for calendar events may also be varied across calendar applications, where this metadata may specify location, attendees, recurrent patterns, and event categories, for example. Thus, with the proliferation of various electronic calendar applications and event management tools from various sources, e.g., electronic calendars from IBM, Google, Samsung, Huawei, Microsoft, and the like, it becomes even more difficult to consolidate events across these various event resources.

The illustrative embodiments provide automated AI based machine learning models that are able to identify duplicative and conflicting event data structures from a variety of different event resources regardless of the specific formatting of the particular event resource. The AI based machine learning models look to patterns of features in the event data structures, based on specific training and learning by the AI based machine learning models, as a mechanism for classifying events as to whether they are duplicative or conflicting and with regard to prioritization of the events relative to one another. As a result, a cross-compatibility of event data structures across multiple different event resources, e.g., different electronic calendar applications having different event data structure formatting and content, is achieved by the mechanisms of the illustrative embodiments as well as an ability to consolidate and prioritize such event data structures across the various electronic calendar applications.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides a personalized event consolidation bot (PECB) framework with PECB server component that operates with PECB client components on one or more data processing systems. The improved computing tool implements mechanism and functionality, such as identifying, evaluating, and modifying event information data structures from the same or different event information data sources so as to perform event management entailing consolidation of duplicate events and prioritization of conflicting events based on machine learning artificial intelligence computer model operations, which cannot be practically performed by human beings either outside of, or with the assistance of, a technical environment, such as a mental process or the like. The improved computing tool provides a practical application of the methodology at least in that the improved computing tool is able to consolidate and prioritize events in electronic calendar based computer systems to thereby resolve duplicate and conflicting events and present event information in a manner that is streamlined and more user friendly than existing electronic calendar based computer systems.

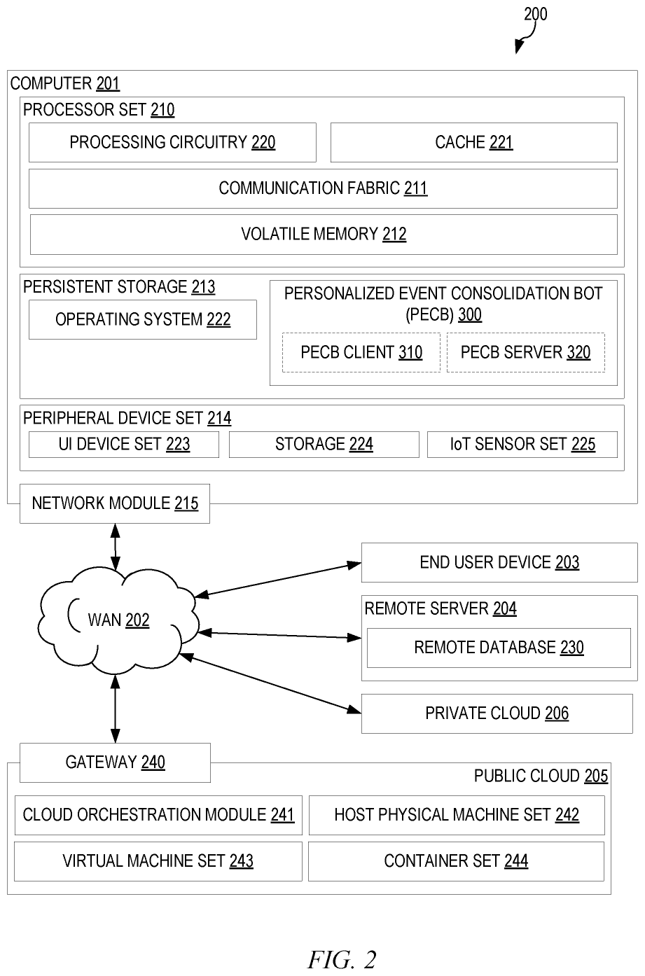

FIG. 2 is an example diagram of a distributed data processing system environment in which aspects of the illustrative embodiments may be implemented and at least some of the computer code involved in performing the inventive methods may be executed. That is, computing environment 200 contains an example of an environment for the execution of at least some of the computer code involved in performing the inventive methods, such as one or more components of a personalized event consolidation bot (PECB) 300. As such, the computing environment 200 may include a PECB server and/or a PECB client. The PECB client 310 may be installed on a client computing device, such as in the form of an application or plug-in to an existing electronic calendar application, and operate to monitor for incoming events and send requests to a PECB server 320 to consolidate and prioritize the events in accordance with one or more of the illustrative embodiments. The PECB server 320 may operate on a server computing device and may respond to PECB client 310 event consolidation/prioritization requests and return the consolidated/prioritized events for rendering by the PECB client 310. It should be appreciated that in some illustrative embodiments, the PECB server 320 and PECB client 310 may be present on the same computing device and in other illustrative embodiments, they may be distributed to different computing devices.

In addition to PECB 300, computing environment 200 includes, for example, computer 201, wide area network (WAN) 202, end user device (EUD) 203, remote server 204, public cloud 205, and private cloud 206. In this embodiment, computer 201 includes processor set 210 (including processing circuitry 220 and cache 221), communication fabric 211, volatile memory 212, persistent storage 213 (including operating system 222 and PECB 300, as identified above), peripheral device set 214 (including user interface (UI), device set 223, storage 224, and Internet of Things (IoT) sensor set 225), and network module 215. Remote server 204 includes remote database 230. Public cloud 205 includes gateway 240, cloud orchestration module 241, host physical machine set 242, virtual machine set 243, and container set 244.

Computer 201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 230. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically computer 201, to keep the presentation as simple as possible. Computer 201 may be located in a cloud, even though it is not shown in a cloud in FIG. 2. On the other hand, computer 201 is not required to be in a cloud except to any extent as may be affirmatively indicated.

Processor set 210 includes one, or more, computer processors of any type now known or to be developed in the future. Processing circuitry 220 may be distributed over multiple packages, for example, multiple, coordinated integrated circuit chips. Processing circuitry 220 may implement multiple processor threads and/or multiple processor cores. Cache 221 is memory that is located in the processor chip package(s) and is typically used for data or code that should be available for rapid access by the threads or cores running on processor set 210. Cache memories are typically organized into multiple levels depending upon relative proximity to the processing circuitry. Alternatively, some, or all, of the cache for the processor set may be located “off chip.” In some computing environments, processor set 210 may be designed for working with qubits and performing quantum computing.

Computer readable program instructions are typically loaded onto computer 201 to cause a series of operational steps to be performed by processor set 210 of computer 201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 221 and the other storage media discussed below. The program instructions, and associated data, are accessed by processor set 210 to control and direct performance of the inventive methods. In computing environment 200, at least some of the instructions for performing the inventive methods may be stored in PECB 300 in persistent storage 213.

Communication fabric 211 is the signal conduction paths that allow the various components of computer 201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, the volatile memory is characterized by random access, but this is not required unless affirmatively indicated. In computer 201, the volatile memory 212 is located in a single package and is internal to computer 201, but, alternatively or additionally, the volatile memory may be distributed over multiple packages and/or located externally with respect to computer 201.

Persistent storage 213 is any form of non-volatile storage for computers that is now known or to be developed in the future. The non-volatility of this storage means that the stored data is maintained regardless of whether power is being supplied to computer 201 and/or directly to persistent storage 213. Persistent storage 213 may be a read only memory (ROM), but typically at least a portion of the persistent storage allows writing of data, deletion of data and re-writing of data. Some familiar forms of persistent storage include magnetic disks and solid state storage devices. Operating system 222 may take several forms, such as various known proprietary operating systems or open source Portable Operating System Interface type operating systems that employ a kernel. The code included in PECB 300 typically includes at least some of the computer code involved in performing the inventive methods.

Peripheral device set 214 includes the set of peripheral devices of computer 201. Data communication connections between the peripheral devices and the other components of computer 201 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 223 may include components such as a display screen, speaker, microphone, wearable devices (such as goggles and smart watches), keyboard, mouse, printer, touchpad, game controllers, and haptic devices. Storage 224 is external storage, such as an external hard drive, or insertable storage, such as an SD card. Storage 224 may be persistent and/or volatile. In some embodiments, storage 224 may take the form of a quantum computing storage device for storing data in the form of qubits. In embodiments where computer 201 is required to have a large amount of storage (for example, where computer 201 locally stores and manages a large database) then this storage may be provided by peripheral storage devices designed for storing very large amounts of data, such as a storage area network (SAN) that is shared by multiple, geographically distributed computers. IoT sensor set 225 is made up of sensors that can be used in Internet of Things applications. For example, one sensor may be a thermometer and another sensor may be a motion detector.

Network module 215 is the collection of computer software, hardware, and firmware that allows computer 201 to communicate with other computers through WAN 202. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer readable program instructions for performing the inventive methods can typically be downloaded to computer 201 from an external computer or external storage device through a network adapter card or network interface included in network module 215.

WAN 202 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 203 is any computer system that is used and controlled by an end user (for example, a customer of an enterprise that operates computer 201), and may take any of the forms discussed above in connection with computer 201. EUD 203 typically receives helpful and useful data from the operations of computer 201. For example, in a hypothetical case where computer 201 is designed to provide a recommendation to an end user, this recommendation would typically be communicated from network module 215 of computer 201 through WAN 202 to EUD 203. In this way, EUD 203 can display, or otherwise present, the recommendation to an end user. In some embodiments, EUD 203 may be a client device, such as thin client, heavy client, mainframe computer, desktop computer and so on.

Remote server 204 is any computer system that serves at least some data and/or functionality to computer 201. Remote server 204 may be controlled and used by the same entity that operates computer 201. Remote server 204 represents the machine(s) that collect and store helpful and useful data for use by other computers, such as computer 201. For example, in a hypothetical case where computer 201 is designed and programmed to provide a recommendation based on historical data, then this historical data may be provided to computer 201 from remote database 230 of remote server 204.

Public cloud 205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 205 is performed by the computer hardware and/or software of cloud orchestration module 241. The computing resources provided by public cloud 205 are typically implemented by virtual computing environments that run on various computers making up the computers of host physical machine set 242, which is the universe of physical computers in and/or available to public cloud 205. The virtual computing environments (VCEs) typically take the form of virtual machines from virtual machine set 243 and/or containers from container set 244. It is understood that these VCEs may be stored as images and may be transferred among and between the various physical machine hosts, either as images or after instantiation of the VCE. Cloud orchestration module 241 manages the transfer and storage of images, deploys new instantiations of VCEs and manages active instantiations of VCE deployments. Gateway 240 is the collection of computer software, hardware, and firmware that allows public cloud 205 to communicate through WAN 202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 206 is similar to public cloud 205, except that the computing resources are only available for use by a single enterprise. While private cloud 206 is depicted as being in communication with WAN 202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 205 and private cloud 206 are both part of a larger hybrid cloud.

As shown in FIG. 2, one or more of the computing devices, e.g., computer 201 or remote server 204, may be specifically configured to implement a portion of a PECB 300 which may include either, or both, of a PECB server and a PECB client. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 201 or remote server 204, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates personalized event consolidation and prioritization of event data structures from the same or different event information data sources.

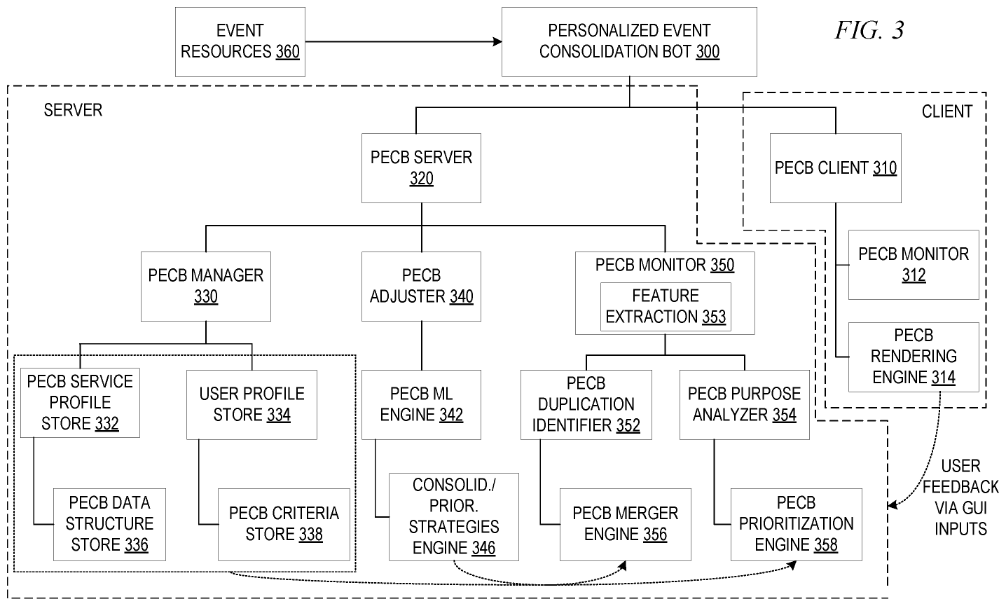

FIG. 3 is an example block diagram illustrating the primary operational components of a personalized event consolidation bot (PECB) framework in accordance with one illustrative embodiment. The operational components shown in FIG. 3 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., event data structures may be created by human beings and added to electronic calendars, event invitation communications may be drafted and sent by human beings which may cause addition of events to electronic calendars, and the like, and the resulting output may aid human beings. The invention is specifically directed to the automatically operating computer components directed to improving the way that event data structures are consolidated and prioritized in an automated manner using machine learning artificial intelligence computer models, and providing a specific solution to the limitations of existing electronic calendar applications and computing systems noted above with regard to duplicate and conflicting event data structures.

As shown in FIG. 3, the PECB framework 300 includes a PECB client 310 and PECB server 320. In some illustrative embodiments, the PECB client 310 and PECB server 320 may be implemented on the same computing device or computing system, such as computer 201 in FIG. 2. In other illustrative embodiments, the PECB client 310 and PECB server 320 may be implemented on different computing devices/systems, such as in a distributed data processing system environment in which client computing devices, on which a PECB client 310 may execute, may communicate with one or more PECB servers 320 via one or more wired/wireless data networks. In a distributed computing environment illustrative embodiment, the PECB server 320 may service requests from a plurality of different PECB client 310 instances executing on a plurality of different client computing devices. The PECB client 310 may be implemented on the client computing devices as a separate installed application executing on the client computing devices or as a plug-in component to another application executing on the client computing devices, such as a plug-in to an electronic calendar application or the like.

The PECB framework 300 operates with event resources 360. The event resources 360 may be a set of calendar and event resources, e.g., personal calendar, company calendar, public event websites, online calendar services, and the like, which provide functionality for creating events, sending invitations to potential event participants, and the like. The event resources 360 may represent different electronic calendar applications or computing devices/systems from which event information data structures may be obtained by the PECB framework 300. The event information data structures may be associated with particular users of the PECB framework 300 and may be associated with those users for purposes of identifying duplicate/conflicting events and resolving such duplication and conflicts in accordance with one or more of the illustrative embodiments. For example, in one illustrative embodiment, the event resources 360 may comprise one or more local electronic calendar computer application, e.g., IBM Notes® available from International Business Machines (IBM) Corporation, Windows Mail® and Microsoft Outlook® available from Microsoft Corporation, Apple Mail® available from Apple, Inc. executing on a client computing device, e.g., mobile smartphone, desktop computer, laptop computer, etc., and associated with the user, one or more organization electronic calendars hosted by an organization computing system, such as the user's employer, one or more online electronic calendars, such as the electronic calendars provided by the open source collaboration platform NextCloud® available from NextCloud GmbH, or the like. The event resources 360 provide event data structures that provide details of the events associated with the various electronic calendars which may include event information such as event name, event organizer identification, date/time information, participant/invitee information, location information, event status information (e.g., confirmed/tentative), reminder notification settings, links for virtual attendance of the event, and any other information that is descriptive of the event and which may be used by the electronic calendar to represent the event in the electronic calendar and its corresponding graphical user interface. Such event data structures, and electronic calendar applications and computing systems are generally known in the art and thus, a more detailed explanation is not needed herein.

It should be appreciated, however, that since the event resources 360 may represent various different types of electronic calendars and sources of event data structures, these event data structures may vary considerably from one another in terms of the types of data, or content, that is present in the event data structures, the location of the various types of data or content, the metadata included, the formatting of the various data and metadata, and the like, as previously mentioned above. Thus, the PECB 300 as described herein, provides a cross-platform event resource consolidation mechanism that leverages artificial intelligence and machine learning mechanisms to be able to identify duplicative and conflicting event data structures across different electronic calendars and event management tools and determine how to consolidate those event data structures and prioritize them relative to one another for rendering in a consolidated view of an electronic calendar.

The PECB server 320 may retrieve the event data structures for a registered user from specified event resources 360. The registration information for a user as well as the identification of the event resources 360 from which to retrieve event data structures may be specified in the user profiles 334. The event data structures may also comprise event data structures obtained from a client computing device (not shown) on which the PECB client 310 is executing, such as when a user of the client computing device uses a local electronic calendar application to create an event. The event data structures may be retrieved by the PECB server 320 and processed in accordance with one or more illustrative embodiments to identify, consolidate, and prioritize duplicate and conflicting event data structures. Such identification, consolidation, and prioritization may be performed automatically as new event data structures are retrieved by the PECB server 320 from event resources 360, or may be performed specifically in response to a PECB request received from the PECB client 310.

The PECB client 310 comprises a PECB monitor 312 and a PECB rendering engine 314 which may be implemented as the engines previously defined above. The PECB client 310 may be a separate application, or a plug-in component to an existing electronic calendar application executing on a client computing device. The PECB client 310 is installed at the application level and operates to consolidate incoming duplicate events, prioritize conflicting events, and render consolidated/prioritized events on top of a human-computer interface (HCI) environment. The HCI environment may be any suitable HCI environment in which humans interact with applications of computing device, such as a chatbot, an electronic calendar application, electronic communication application, electronic desktop of a computing device, and the like. The PECB client 310 may request operation by the PECB server 320 to perform the consolidation and/or prioritization and may render the results at the local client computing device for output as part of a graphical user interface of the HCI environment, e.g., as part of a displayed electronic calendar, a chatbot interface, or the like.

For example, in some illustrative embodiments, the PECB client 310 may operate in conjunction with a chatbot application through which natural language interaction is performed. In so doing, the PECB client 310 may detect requests by a user, such as via the PECB monitor 312, as to event information and may initiate event consolidation/prioritization by the PECB server 320 in response. The PECB client 310 may then respond to the user through natural language conversational outputs of the chatbot specifying the results of the consolidation/prioritization performed by the PECB server 320 and communicated as results to the PECB client 310. The PECB client 310 may further interface with a local electronic calendar application to graphically and textually represent the event in an electronic calendar format, such as via the PECB rendering engine 314.

Thus, the PECB monitor 312 comprises computer executed logic to monitor for requests by a user for event information, creation of events via the client computing device, and in some cases incoming events from other event resources 360, such as event invitations from other users of other devices, and send requests to the PECB server 320 in such cases to perform event consolidation and prioritization. The PECB rendering engine 314 provides computer executed logic that operates to graphically and textually represent the consolidated and/or prioritized events in a manner that represents their prioritized order and their merged or consolidated event data structures for ease of use by a user.

The PECB server 320 comprises a PECB manager 330, a PECB adjuster 340, and a PECB monitor 350. These components of the PECB server 320, as well as their subcomponents, may be implemented as various engines as defined previously. The PECB server 320 receives PECB client 310 requests for event consolidation/prioritization and returns the consolidated/prioritized event data and layout information for use by the PECB rendering engine 314 to render a graphical user interface representation of the consolidated/prioritized event data, such as in the form a consolidated/prioritized calendar graphical user interface, prioritized listing of events, or the like.

The PECB manager 330 of the PECB server 320 provides a user interface for allowing users to configure PECB settings and PECB criteria, such as which event resources 360 to monitor, e.g., personal calendar, company calendars, public event platforms, customer management systems, and the like, which types of events (e.g., work meetings, telephone calls, web conferences, etc.) that are of interest and what portions of event information to evaluate when performing consolidation and/or prioritization, e.g., event names, agendas, time, duration, location, calling number, hostname, key speaker, participant name, agenda, etc. The PECB settings and criteria may further specify merge thresholds, e.g., a threshold similarity measure needed to merge two duplicate event data structures, layout priority colors or other graphical characteristics for representing event data structures of different priorities, e.g., red for high priority, blue for medium priority, etc., which consolidation strategies to enable/disable, and the like.

The PECB manager 330 has subcomponents including a PECB service profile store (storage such as memory, solid state drive, hard disk, or the like) 332, a user profiles store 334, a PECB data structure store 336, and a PECB criteria store 338. The PECB service profile store 332 stores configuration files for saving the configured PECB settings for different registered users, i.e., users that have corresponding user profiles in the user profiles store 334. The PECB service profile store 332 correlates the PECB service profiles with corresponding PECB data structures in the PECB data structure store 336. It should be noted that hereafter, for ease of explanation, the present description may make reference to the reference number in the figure when referring to the particular data structure that would be stored in the corresponding store, e.g., a user profile 334 refers to the user profile data structure for the user as stored in the user profile store 334. Similarly, other references to the data structures, algorithms, and the like that are implemented in the various depicted elements may be referenced by the same reference numeral as the depicted element, e.g., the following description may make reference to the consolidation/prioritization strategies 346 which are actually strategies implemented in and by the consolidation/prioritization strategies engine 346.

The PECB data structures in the PECB data structure store 336 comprise data defining a special PECB data structure for tracking events in an electronic calendar and specifying a mapping between one or more original events in an original event list and one or more consolidated/prioritized events in a layout event list, where the layout event list is a listing of consolidated/prioritized events. For example, in some illustrative embodiments, the PECB data structures in store 336 may be of a type: PECB_Data (UserID, CalendarID, Timeslot, OriginalEventList [EventID][EventData], LayoutEventList [EventID][EventTitle][Purpose][Priority]), where the userID specifies the particular user and may be used to map the PECB data structure to user profiles 334, the calendarID specifies a particular electronic calendar that is the principle electronic calendar from which original event data structures are obtained and with which other event data from the same or different event resources 360 are consolidated, the timeslot specifies the particular day/time in the electronic calendar for which the PECB data structure is generated, the original event list specifies the event identifier and event data for an original event in the principle electronic calendar, and the layout event list specifies the event identifier, event title, purpose, and priority of the consolidated/prioritized event corresponding to the original event. Multiple PECB data structures may be provided for a user and for different electronic calendars of the user, such as one for each original event, such that a set of PECB data structures may be present for each user and each electronic calendar of each user. The PECB data structures are specialized data structures that store the attributes for analyzing, merging, and prioritizing events to thereby consolidate events determined to be duplicative or conflicting.

The user profiles store 334 comprises user profile data structures which not only store the information about the particular registered user, e.g., user identifier, security information, e.g., password, and other routine user account information, but also stores or links the user profile with the PECB criteria in PECB criteria store 338 which are to be used when performing consolidation and prioritization of event data structures for this user's electronic calendar events. The PECB criteria in the PECB criteria store 338 associated with a user profile may comprise a specification for a set of rules for defining the PECB service as it is provided for the specific user. The specifications for the set of rules may include base variables, such as event resources that are to be monitored (e.g., personal calendar, company calendars, customer management systems, and public event platforms), event data to use as a basis for consolidation/prioritization (e.g., event name, agenda, time, duration, location, calling number, hostname, key speaker, participant name, agenda), merge thresholds, layout priority colors and portions, and which consolidation strategies to enable/disable, etc. The PECB criteria may be customized for each of the registered users in the user profiles store 334 so as to meet those users personal preferences and needs.

The PECB adjuster 340 comprises computer executed logic to perform adjustments to consolidation strategies, in consolidation strategies store 346, to apply to duplicate and/or conflicting events. The consolidation strategies themselves may be implemented as computer executed consolidation strategy rules and/or algorithms that are executed on the duplicate or conflicting event data structures, which may be identified by the PECB monitor 350. The PECB adjuster 340 may also operate on information obtained from PECB manager 330, such as user profiles in user profiles store 334 specifying the enabling/disabling of specific consolidation strategies, PECB data structures in PECB data structure store 336 specifying settings for the PECB service for this user, and the like.

As shown in FIG. 3, the PECB adjuster 340 has subcomponents comprising a PECB machine learning (ML) engine 342 and consolidation/prioritization strategies engine 346. The PECB ML engine 342 comprises logic that performs machine learning operations based on existing merged and prioritized samples, such as provided by users and/or administrators, in order to define and update consolidation strategies for identifying and mering similar events, prioritizing events, and handling event conflicts. For example, the PECB ML engine 342 may receive 1000 merged samples which were merged by a user manually according to similarities of title, content, participants, etc., and the PECB ML engine 342 comprises logic for parsing these samples, extracting features from these samples, and learn from the samples the patterns of features and the resulting operations performed, e.g., merging, prioritizing, and conflict resolution operations, so as to learn a mapping of feature patterns to corresponding operations. Based on such mappings from these existing samples, consolidation strategies may be automatically generated that specify patterns of features as conditions and consolidation operations as resulting operations to be performed when such patterns of features are encountered.

The consolidation/prioritization strategies (hereafter referred to collectively as consolidation strategies) 346 comprise computer executed sets of rules or algorithms that operate to resolve duplicate event data structures and/or conflicting event data structures. It should be appreciated that duplicate event data structures need not be identical, but are determined, through application of one or more trained machine learning models, as discussed hereafter, to be sufficiently similar in their features that they are regarded as representing the same event. Conflicting event data structures are event data structures directed to different events, i.e., events that do not have sufficiently similar features, but which have some degree of overlapping in date/time and/or location such that it may not be practical for a user to be involved in each of the events, e.g., one cannot be at a family event in Dallas, Texas and also be present at a work meeting in Tulsa, Oklahoma on the same day at approximately the same time.

The consolidation strategies 346 may be varied and may be applied to different portions of the event data structures in different ways. The particular consolidation strategies 346 to apply will depend on the user profile 334 enablement of different consolidation strategies, if any (note that a default set of consolidation strategies may be applied unless overridden by the user in their user profile), the particular portions of the event data structures that are to be evaluated for merging/prioritization, the particular PECB service settings specified in the PECB data structure 336, and the like. For example, the consolidation strategies may comprise sets of computer executed rules and/or algorithms that are directed to event attribute comparison, merging event details, handling conflicting details, prioritizing event resources, participant handling, conflict resolution, update reminders and notifications, and data validation.

With regard to event attribute comparison, the consolidation strategies 346 operate to compare extracted features of event data structures, such as title, date, time, location, and participants, where the extracted features may be extracted by natural language processing (NLP) and other parsing logic of the PECB monitor 350 as discussed hereafter. A threshold level of similarity, or threshold similarity measure, may be specified in the PECB service profile 332, e.g., as part of the PECB data structure 336, to identify duplicate events, such that events with a determined degree of similarity that meets or exceeds the threshold similarity measure can be considered duplicates and subject to consolidation through merging of their event data structures.

With regard to merging event details, the consolidation strategies 346 comprise sets of rules and/or algorithms to merge relevant details from each duplicate event data structure into a single entry. This can include combining event descriptions, merging participant lists, and updating event properties, like duration or location, for example.

Regarding the handling of conflicting details, such as in the case of duplicate event data structures that have different details but are determined to be directed to the same event, the consolidation strategies comprise sets of rules and/or algorithms for resolving the conflicting details. For example, if two events have different start times but overlapping durations, the consolidation strategies can choose a new start time that accommodates both durations.

With regard to prioritizing event resources, the consolidation strategies 346 comprise sets of rules and/or algorithms to evaluate the importance or relevance of event resources 360 from which event data structures are received so as to give differing levels of prioritization to event data structures based on their sources. The rules/algorithms may evaluate various indicators of the source of the event data structures, including event organizer identifiers, specific electronic calendars from which the event data structures are received, other participants invited to the event, a specified priority of the event by the event organizer, and/or other features of the event data structure indicative of importance of the event relative to other events. Such prioritization may be used not only in determining relative priority of conflicting events, but may also be used with other consolidation strategies, such as the handling of conflicting details or merging of event details, to determine which details are retained or prioritized during the consolidation process.

Regarding participant handling, the consolidation strategies 346 comprise sets of rules and/or algorithms to handle participants of duplicate events when there are overlapping participants, to ensure they are included in the consolidated event only once. The rules/algorithms comprise logic for handling participant conflicts or discrepancies, such as using the most recent or authoritative participant list.

With regard to conflict resolution strategies, the consolidation strategies 346 comprise sets of rules and/or algorithms to resolve conflicts that arise when consolidating events, which may include determining which event's details take precedence, providing alternative options to participants, or seeking user input to resolve conflicts manually. These may be conflicts between duplicate event data structures, for example, to determine what details to include in the merged event data structure that is generated as a result of consolidating the duplicate event data structures, determining how to modify the details to encompass the details of both event data structures that may be in conflict with one another, and the like. These may also be conflicts between different event data structures for different events that conflict in date/time and/or location with the consolidation strategies operating to determine which event data structures should be given higher priority.

With regard to update reminders and notifications, the consolidation strategies 346 comprise sets of rules and/or algorithms that operate such that, if the consolidated event has reminders or notifications associated with it, the rules and/or algorithms ensure they are adjusted or merged accordingly. The rules/algorithms operate to update notification settings based on the consolidated (merged) event's properties to avoid duplication or confusion. For example, a NLP summarization feature may be applied to all notifications of the event data structures and a new notification may be generated. For example, assume that there are three events, e.g., event 1: you have a dental appointment at 10am, event 2: Please note that, there is a dental appointment scheduled at 10am, and event 3: reminder—dental appointment at 10:00am at 400 Main Street. With this example, the consolidation strategies 346 may implement NLP summarization logic to generate a new notification and corresponding settings (e.g., notify 30 minutes before event), of the type: Subject-Dental Appointment Reminder, Notification: You have a dental appointment scheduled for 10:00 AM at 400 Main Street.

Regarding data validation, the consolidation strategies 346 comprise sets of rules and/or algorithms that operate to implement validation checks to ensure the integrity and consistency of the consolidated (merged) event data structures. The validation checks may involve sending acknowledgement requests to the user and/or other attendees of the event to accept the consolidated event data structure with tracking records to track which users/attendees have accepted the consolidated event data structure. If the user accepts the consolidated event data structure then it is validated and indicates that the consolidation of the event data structure was performed correctly. If the user rejects the consolidated event data structure, then the consolidation may be automatically rolled back or undone. The consolidation strategies 346 may further verify that all necessary attributes are populated, and the consolidated event adheres to any predefined rules or constraints.

These consolidation strategies 346 may be applied by the PECB merger engine 356 and PECB prioritization engine 358 of the PECB monitor 350, for example, when performing consolidation or merging of duplicate event data structures and when prioritizing conflicting event data structures, for example. Thus, based on these consolidation strategies 346 and the settings and criteria specified in the PECB data structure 336 and PECB criteria 338 for the user associated with the event data structures, duplicate and conflicting event data structures may be consolidated into merged event data structures and prioritized event data structures with a corresponding layout specification for use by the PECB rendering engine 314 at the PECB client 310 to use when presenting event information via an electronic calendar graphical user interface and/or prioritized event listing interface. It should be appreciated that in some cases, the consolidation operation may, for a given event data structure, entail both consolidation of duplicate event data structures and prioritization of the resulting merged event data structure with other event data structures that are determined to be conflicting with the merged event data structure.

The PECB monitor 350 comprises the computer executed logic for monitoring event data structures obtained from the event resources 360 and/or client computing device on which the PECB client 310 is operating, and classifying the event data structures relative to other event data structures of an overlapping time period, e.g., date/time, and/or possible location, present in the same or different electronic calendars of the various event resources 360 and client computing device. That is, for an incoming event data structure that is identified by the PECB monitor 350, the PECB monitor 350 identifies other event data structures for the same user in the same electronic calendar and any other electronic calendars that the user's profile 334 specifies are to be monitored, e.g., as specified in the user's PECB criteria 338. The PECB monitor 350 may execute feature extraction logic 353 on the identified potentially duplicative or conflicting event data structures to extract features from each of these event data structures. The feature extraction logic 353 may operate on different portions of the event information in the event data structures separately, e.g., on the event name, on the event description, on the invitee or participant listing, etc. to extract corresponding features indicative of that portion of the event data structure. The feature extraction logic 353 may utilize natural language processing (NLP) algorithms to parse natural language text of portions of the event information to extract key terms/phrases and the like that may be used for comparison to extracted features of other event data structures to determine a degree of similarity.

In performing the feature extraction, the features that are extracted may be used to generate a vector representation of the extracted features which is used as input to one or more machine learning computer models, e.g., the PECB duplication identifier 352 and the PECB purpose analyzer 354, for classification. That is, each event data structure may have feature extraction performed on it to generate a corresponding feature vector. Pairings of feature vectors may be input to the one or more machine learning computer models which will then classify the pair of feature vectors with regard to predefined classifications, e.g., similar or not similar in the case of PECB duplication identifier 352. In some cases, each vector representation may be separately analyzed by one or more machine learning computer models to classify the vector representation with regard to a set of predefined classifications, e.g., classifications of predetermined event purpose in the case of the PECB purpose analyzer 354. The resulting classifications may be output to the corresponding PECB merger engine 356 and PECB prioritization engine 358 for performing their functions based on these classifications.

Thus, in some illustrative embodiments, the PECB duplication identifier 352 comprises one or more machine learning computer models for analyzing the extracted features of a plurality of event data structures, the features representing the event data for the event, and identifying duplicate events. The features representing the event data may include the event name, agenda, time, duration, location, calling number, hostname, key speaker, participant name, or any other event data that may be present in an event data structure and which may be used as a basis for determining a measure of similarity between event data structures. The PECB duplication identifier 352, in analyzing the extracted features for the event data structures, generates a measure of similarity between the extracted features, e.g., a vector similarity metric using vector similarity analysis, which may then be compared to a predefined threshold level of similarity to determine if the events are sufficiently similar to warrant consolidation or merging of their event data structures. That is, if the feature vectors of the event data structures have a measure of similarity equal to or above the predefined threshold similarity measure, then the event data structures are sufficiently similar to warrant consolidation/merging. If the feature vectors of the event data structures do not have a measure of similarity equal to or above the predefined threshold similarity, then these event data structures may not be duplicative and instead may be considered as associated with potentially conflicting events.

The PECB duplication identifier 352 comprises computer executed logic for training one or more machine learning computer models, e.g., neural networks or the like, to specifically classify event data structures as being duplicate event data structures based on their feature vector representations. In training the one or more machine learning computer models, training datasets comprising training event data structures and their corresponding feature vectors are used to train the one or more machine learning computer models to recognize patterns of features of the event data structures that are indicative of duplicate events. The training event data structures and feature vectors have corresponding ground truth data specifying whether two (or more) event data structures are in fact duplicates or are not duplicates. The machine learning training process involves processing the feature vector representations of the event data structures and generating a predicted classification of whether the event data structures are duplicative or not, with a corresponding similarity measure or metric being generated to indicate how similar the feature vectors are to one another, e.g., a vector similarity metric. The result is compared to the ground truth and the comparison results in an error or loss value being determined. This error or loss value is then used by the machine learning algorithms, e.g., linear regression or other curve fitting regression type learning, to adjust operational parameters of the machine learning computer model(s) to try to reduce the error or loss. This is done over a large number of training data until the error/loss is below a given threshold or until a predetermined number of epochs or iterations have been executed. In this way, the PECB duplication identifier 352 learns correspondence between patterns of features in the input feature vectors and corresponding similarity measures and outcomes of whether the feature vectors are indicative of duplicative event data structures.

In a similar fashion, one or more machine learning computer models of the PECB purpose analyzer 354 may be trained using machine learning algorithms and a training dataset of feature vectors for event data structures. As opposed to the PECB duplication identifier 352, the machine learning computer model(s) of the PECB purpose analyzer 354 may operate on a feature vector for a single event data structure and determine a classification of the event data structure with regard to one of a plurality of possible predefined purpose classifications. That is, there may be a predetermined set of 100 different recognizable purposes for events. The machine learning computer model(s) of the PECB purpose analyzer 354 are trained to generate probability values for each of these possible classifications based on an analysis of the features of the event data structure as indicated in the input feature vector. The probability values indicate which classification is most likely to represent the purpose of the event, e.g., the highest probability value is associated with the predicted purpose of the event. When performing the machine learning training, the training dataset will have ground truth data that specifies what the true purpose is of the event and this may be compared to the predicted purpose to determine the error/loss and execute machine learning algorithms to reduce this error/loss by modifying operational parameters of the machine learning computer model in a similar way as noted above with the PECB duplication identifier 352.

For example, similarities of event data (event name, agenda, time, duration, location, calling number, hostname, key speaker, participant name, etc.) may be used by the PECB duplication identifier 352 to identify duplicated events. The event descriptions may be used to analyze the event purpose (e.g., customer support meeting, education, project status meeting, invention discussion with coinventors, 1×1 meeting with friend, etc.) and this event purpose can be digitized (0˜10) for prioritizing the event order and how the events will be represented in the layout of the electronic calendar and/or prioritized event listing.

Based on the classifications by the PECB duplication identifier 352, the PECB merger engine 356 executes computer logic for merging the duplicated events into a single event data structure and an updated event list. The PECB merger engine 356 may invoke various ones of the consolidation strategies 346 discussed above to resolve any conflicts in content of the event data structures when performing the merging of the event data structures, and to remove or at least minimize any duplication of information, participants, or the like, associated with the event data structures that are being merged. In some cases, adjustment of start times may be made to accommodate the start times and durations of the plurality of event data structures that are being merged such that a new start time is provided of the merged event data structure which is different from at least one of the start times of the event data structures being merged, and possibly different from all of the start times of the event data structures being merged.

The PECB prioritization engine 358, based on the purpose classifications from the PECB purpose analyzer 358, executes computer logic that prioritizes the conflicting event data structures according to event purpose and the consolidation strategies 346 specifying a relative prioritization for the various purposes. The PECB prioritization engine 358 may further evaluate additional factors other than just the predicted purposes of the conflicting event data structures in order to determine a relative priority of the conflicting event data structures. For example, the users associations with the event organizer, the other participants, and the like, may be used to evaluate the relative priority of the event data structures, e.g., if the event data structure has a purpose of project status meeting and the event organizer is the user's supervisor, then that event data structure may have a higher priority than a 1×1 meeting with a friend. As another example, a history of prior event data structures and user feedback as to whether they attended the event or canceled the event may be used as a basis for prioritizing other event data structures for events having similar classifications, e.g., if a user routinely canceled events that have an event type of 1×1 meeting with a friend, then if there is a current conflict and one of the events is of this type, then it may be selected to have a lower priority than the other conflicting event data structures. However, in other situations, if the same event is routinely canceled by the user and has been canceled more than a threshold number of times, it may be a basis for elevating the priority of the event data structure to a higher priority, e.g., if the user has been canceling a meeting with a friend, it may be important to elevate this priority to avoid damaging the friendship.

The user and administrators may establish various factors for prioritization in the user profiles 334 and/or PECB service profile 332 or PECB criteria 338 which may be implemented by the PECB prioritization engine 358 when determining prioritization of events. These factors may include conditional factors rather than just static independent values. As one example, a user may specify that if a first attendee (Name 1) and a second attendee (Name 2) in the participant list for an event have accepted the invitation to the event, then the event priority may be elevated to a highest priority. In another example, a user may specify a rule or logic that evaluates a condition and dynamically makes a modification to the priority of the event based on dynamic changes to the status of the event, e.g., a user can set a prioritizing rule that specifies to increase the priority scoring of the event by 1% for each participate that is in a user's customer list, or for each participant that accepts the invitation to the event, or any other suitable condition.

Based on the results of the processing by the PECB merger engine 356 and the PECB prioritization engine 358, merged/consolidation event data structures are generated and prioritized event data structures for conflicting events are generated and provided back to the PECB server 320 logic for creation of a layout for an electronic calendar and/or prioritized listing of events. The PECB server 320 generates the layout as a data structure for specifying how to render the merged/consolidated event data structures and the prioritized event data structures in the associated electronic calendar of the client computing device on which PECB client 310 is operating. The PECB server 320 then returns this layout and prioritized event data structures to the PECB client 310 as a response to its original request.

The PECB rendering engine 314 of the PECB client 310 then operates in conjunction with a local electronic calendar application or event management application to represent the event data structures in accordance with the layout provide by the PECB server 320. The presentation of such event data structures in the local electronic calendar application or event management application may, for example, overlay the event data onto the calendar graphical user interface such that the events are depicted at appropriate dates and times represented in the electronic calendar display. In addition, the event data structures may have their representations modified, through coloring, shading, highlighting, different fonts, or any other mechanism, to represent the relative priorities of conflicting event data structures in the graphical user interface. In addition, a popup or separate graphical user interface may be provided to present a prioritized listing of conflicting event data structures to thereby suggest to a user which events are relatively higher priority than others. This prioritized event listing may utilize similar coloring, shading, highlighting, fonts, etc. to that of the representation of the conflicting events in the electronic calendar itself. These representations of the event in the electronic calendar and/or event listing may include user manipulatable user interface elements through which a user can indicate their acceptance or rejection of the specific results generated by the mechanisms of the illustrative embodiments, and thereby provide user feedback to the PECB server 320 via the PECB client 310 which may be used to dynamically update the operational parameters of one or more of the machine learning computer models of the PECB server 320 so as to reduce error. For example, the user input to the user interface elements may be used as a ground truth for determining error and modifying operational parameters, e.g., weights of nodes or the like, of the machine learning computer model to thereby adjust its operation and performance to be more accurate to the user.

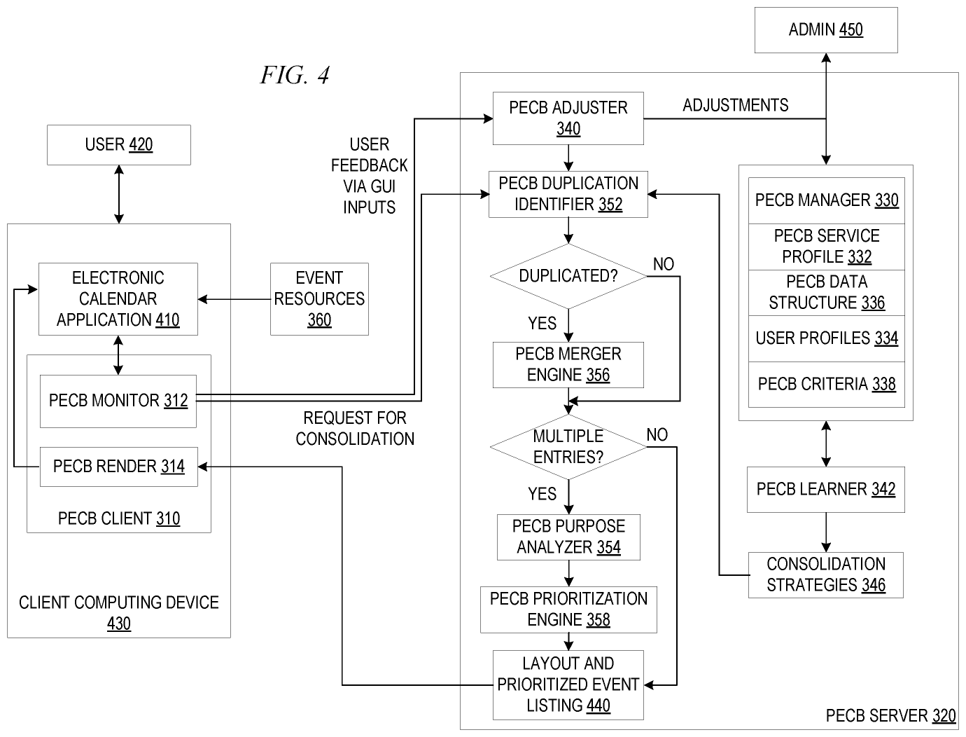

FIG. 4 is an example flow diagram illustrating the operation and interaction of the components of the PECB framework in accordance with one illustrative embodiment. Similar elements to those discussed above with regard to FIG. 3 are shown in FIG. 4 with similar reference numerals. As shown in FIG. 4, a user 420 interacts with an electronic calendar application (or simply calendar) 410 on a client computing device 430 which also executes the PECB client 310. The electronic calendar 410 may compile event data structures from one or more event resources 360, which again may be other electronic calendar event data structure sources, such as work electronic calendars, public event computing systems, other user's electronic calendars, electronic communications specifying event invitations, and the like, which may be provided by different computing systems and different applications than the calendar 410. The event data structures are pulled/pushed from these event resources 360 and received at the client computing device for representation in a graphical user interface of the electronic calendar 410. As such, some of these event data structures from the event resources 360 may be duplicative or may conflict with the date/time and/or location of other scheduled events, and the event data structures may have varying content, formatting, metadata, and the like, based on the particular source from which the event data structure is obtained.

The PECB monitor 312 monitors these event data structures as they are received from the event resources 360 and invokes the PECB server 320 to perform consolidation and prioritization of the event data structures by sending a request to the PECB server 320. In addition, the PECB monitor 312 may monitor for user feedback via user 420 input to the calendar 410 in response to results of the consolidation and prioritization, e.g., a user changing the priority of an event data structure through interfacing with graphical user interface (GUI) elements of the calendar 410 will cause user feedback to be provided to the PECB adjuster 340 which may then adjust one or more of the PECB service profile 332, the user profiles 334, PECB criteria 338, or the like, and the PECB learner 342 may then learn modifications to the consolidation strategies 346 based on this user feedback.

The PECB duplication identifier 352 receives the request from the PECB monitor 312 and evaluates the event data structure as to whether it is a duplicate with other event data structures having a similar date/time and/or location as specified in the calendar 410. If it is determined that the event data structure is a duplicate, the PECB merger engine 356 is invoked to merge the event data structures that are determined to be duplicative. Thereafter, or if the event data structure is not determined to be duplicative, a determination is made as to whether there are multiple event data structures, or entries, which are conflicting with each other in date/time and/or location. If there are, then the PEDB purpose analyzer 354 and PECB prioritization engine 358 are invoked to evaluate the purpose of the multiple event data structures and prioritize the multiple event data structures relative to each other. The result of the operation of the PECB merger engine 356 and the PECB prioritization engine 358 are then used to generate a layout and prioritized event listing 440 which is returned to the PECB client 310. At the PECB client 310, the layout and prioritized event listing 440 are used by the PECB rendering engine 314 to update the graphical user interface of the electronic calendar 410 to represent the duplicate event data structures as a single merged event data structure, and graphically/textually represent the relative priorities of the conflicting event data structures in the electronic calendar 410 and in some cases as a separate prioritized event listing.

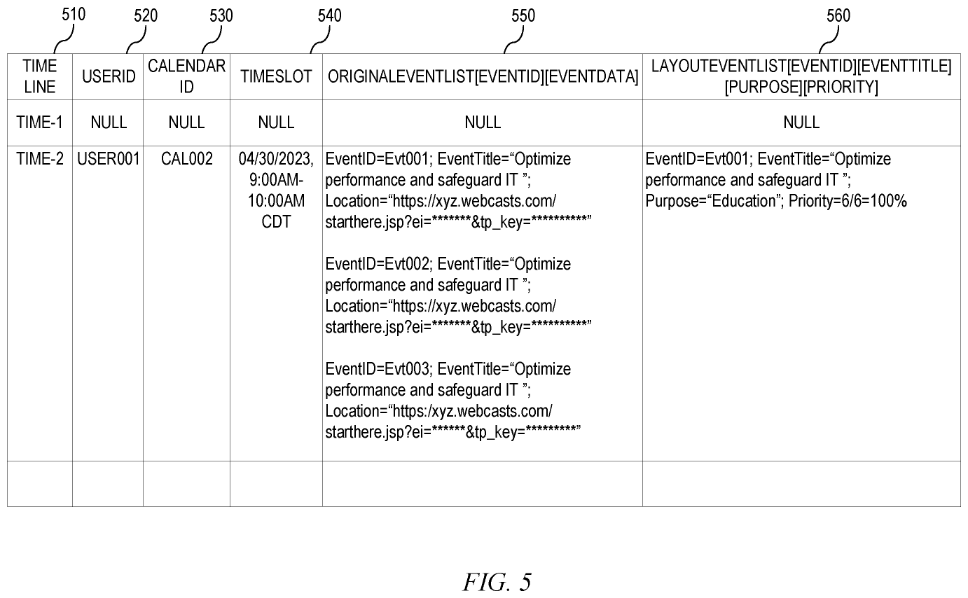

As noted above, the illustrative embodiments operate to identify duplicate event data structures for electronic calendar events by using machine learning computer models to evaluate various features extracted from the event data structures. FIG. 5 is an example diagram of event data structures in which duplicate events are present and a corresponding merged event data structure in accordance with one illustrative embodiment. The data structure shown in FIG. 5 is only exemplary and any suitable data structure format and content for representing an event may be used without departing from the spirit and scope of the present invention.

The data structure shown in FIG. 5 is organized by date/time as represented on the left hand side of the table such that events that are at the same date/time are represented in the same row of the data structure. Thus, as shown in FIG. 5, there is a first column 510 for the timeline, a second column 520 for specifying the user to which the event data structures correspond, a third column 530 to specify which electronic calendar the event data structures are associated with, a fourth column 540 to specify the timeslot in the electronic calendar with which the events are associated, a fifth column 550 in which the original event listing, and a sixth column 560 in which the layout event listing is presented. In this example, the original event list 550 specifies the events by “EventID” with their corresponding extracted features, such as Event Title, Location, and the like. The layout event listing represents the merged event data structure after consolidation of duplicate event data structures is performed.

As shown in FIG. 5, there are 3 event data structures, i.e., EventID=Evt001, EventID=Evt002, and EventID=Evt003. Each of these events have similar titles and locations. The similarity of the event data structures may be evaluated by the trained machine learning computer models of the PECB duplication identifier engine 352 based on the extracted features, e.g., natural language processing on the title, evaluation of the similarity of the location, and the like, which may be represented as feature vectors. Thus, when extracting features from these events and evaluating similarities between the events, as previously discussed above, the similarities of the titles and locations will result in a finding that the event data structures Evt001, Evt002, and Evt003 are all directed to the same event and thus, are duplicative of one another. As a result, a consolidated event data structure may be generated as shown in column 560, where this consolidated event data structure represents a merging of the separate event data structures in column 550 into a single event data structure.

Thus, through operation of the present invention, these three event data structures are merged into a single event data structure which replaces the duplicative event data structures and thus, is given the EventID=Evt001 in column 560. The merged event data structure retains the title of the original event data structures and further includes a predicted classification of the event purpose and corresponding priority. The predicted purpose classification may be generated through the operation of the machine learning computer models to of the PECB purpose analyzer 354 to classify the extracted features of the event data structures into predetermined purpose classifications and generating probability values, or scores, for each of the predetermined purpose classifications. The priority of the event data structure may be determined by the PECB prioritization engine 358 by executed appropriate consolidation strategies 346 on the purpose classification as well as other factors to determine a relative priority of the event data structure.

It should be appreciated that the event data structures need not have the exact same titles, locations, or other attributes, but may still be regarded as sufficiently similar as to be representing the same event. As noted above, a vector representation of the extracted features of the event data structures may be used along with a vector similarity determination with similarity threshold values being used to determine whether two or more vectors are sufficiently similar to one another to represent the same event. For example, assume that there are two events with a same title and location, but different content/descriptions, e.g., Event 1: “Thank you for registering to attend the Web Broadcast. Login will be available 30 minutes prior to the event start time. We look forward to your participation in this broadcast”; Event 2: “Thank you for your registration. Please login on time.” Based on NLP feature extraction and meaning analysis, there is no key difference on time, location, subject, and object between the two events, as may be represented by the vector embedding of the features extracted from the event data structures. Therefore, both events are determined to be directed to the same event and can be merged into a consolidated event data structure.

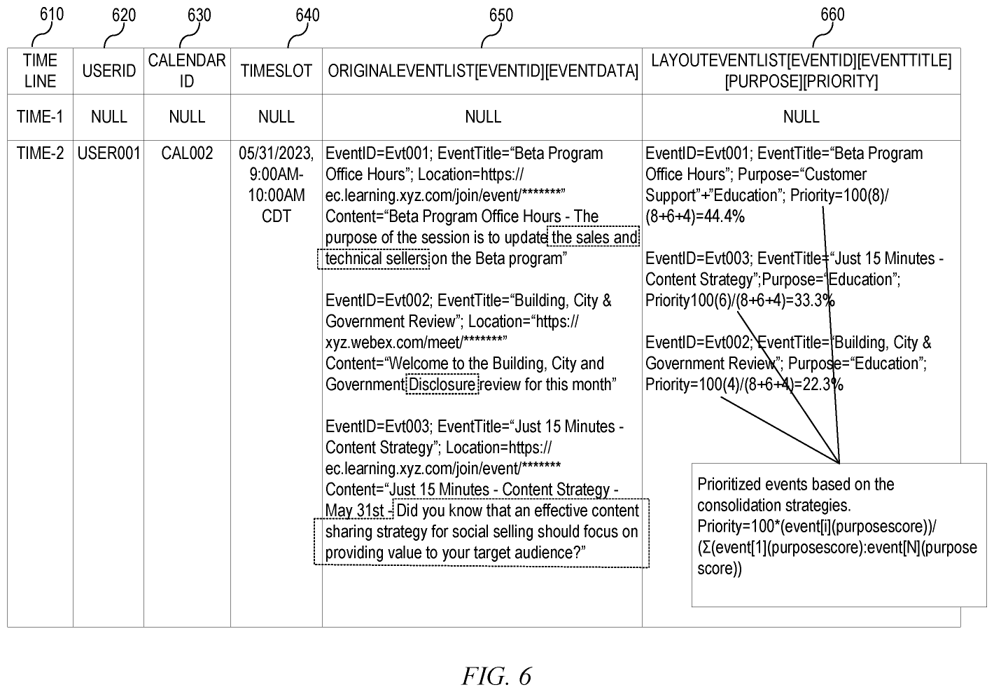

FIG. 6 is an example diagram of event data structures in which conflicting events are present and a prioritized event list layout in accordance with one illustrative embodiment. Columns 610-660 in FIG. 6 are similar to columns 510-560 in FIG. 5. Notably, however, the event data structures in the original event list 650 comprise features which indicate that the events are not duplicative and are in fact conflicting events scheduled at the same timeslot 640. For example, as shown in column 650, the first event (Evt001) has a different title, different location, and different content than other events, and vice versa. As such, the events cannot be merged into a single consolidated event data structure and are in fact conflicting events. As with the example in FIG. 5, the events are evaluated via the PECB purpose analyzer 354 and PECB prioritization engine 358 to thereby generate predicted purpose classifications and relative priorities. In this example, the priority evaluation is based on a function of the predicted event purpose classification's priority relative to a sum of the event purpose classification priorities of the other conflicting event data structures. Thus, for example, assume that the priority score for the first event is 8, the priority score for the second event is 6, and the priority score for the third event is 4, where these priority scores are assigned according to the consolidation strategies based on the predicted purpose classifications and possibly the evaluation of other factors as previously mentioned above. In the depicted example, the consolidation strategy assigns a value of 8 to customer support events, a value of 6 to education events, a value of 5 to status meeting events, a value of 4 to invention discussion events, and a value of 3 to 1×1 meeting events.

Using the example formula shown in FIG. 6, the relative priorities of the events are then calculated to be 44.4%, 33.3%, and 22.3%, respectively. Hence the first event data structure has the highest priority, the second event data structure has the second highest priority, and the third event data structure has the third highest priority. These relative priorities may be represented in a prioritized event listing data structure and as different graphical/textual features of the event data structures in the rendering of the events as part of an electronic calendar.

Thus, the illustrative embodiments provide an improved computing tool and improved computing tool operations/functionality for automatically resolving duplicate and conflicting event data structures which may be received from various sources. The illustrative embodiments provide machine learning and artificial intelligence based mechanisms for evaluating event data structures to determine which event data structures are likely duplicative of each other and which are conflicting of each other. The illustrative embodiments further provide automated computing tools and computing tool operations/functionality for merging duplicative event data structures into a single combined event data structure, and for prioritizing conflicting event data structures based on a predicted purpose classification for each of the conflicting event data structures. The illustrative embodiments also provide mechanisms for generating a layout and prioritized event listing for use in rendering the event data structures, and consolidated/merged event data structures, in an electronic calendar.

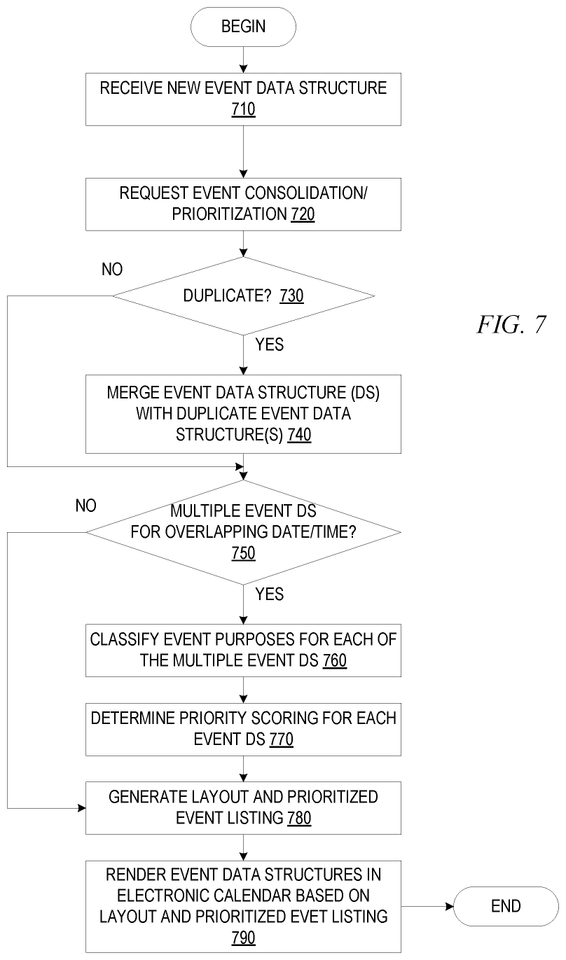

FIGS. 7-9 present flowcharts outlining example operations of elements of the present invention with regard to one or more illustrative embodiments. It should be appreciated that the operations outlined in FIGS. 7-9 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIGS. 7-9, and may, in some cases, make use of the results generated as a consequence of the operations set forth in FIGS. 7-9, the operations in FIGS. 7-9 themselves are specifically performed by the improved computing tool in an automated manner.

FIG. 7 is a flowchart outlining an overall operation of a personalized event consolidation bot in accordance with one illustrative embodiment. As shown in FIG. 7, the operation starts by receiving a new event data structure into an electronic calendar application associated with a personalized event consolidation bot (PECB) client (step 710). A request is sent to the PECB server to perform event consolidation and prioritization of the received event data structure relative to other event data structures already associated with the electronic calendar (step 720). A first determination is made as to whether the event data structure is a duplicate of at least one other event data structure (step 730). If so, then the event data structure is merged with the at least one other event data structure (step 740).

Thereafter, or if the event data structure is not a duplicate event data structure, a second determination is made as to whether there are still multiple event data structures associated with the same date/time as the received event data structure (step 750). If so, then it is determined that there are conflicting event data structures and the purpose classification of each of the conflicting event data structure is predicted (step 760). Based on the predicted purpose classifications of the event data structures, and optionally other factors that are indicative of relative priority of the events, a relative priority score for the event data structures is generated (step 770). Based on the consolidation/merging of event data structures, if any, and the prioritization of event data structures, a layout and prioritized event listing is generated and sent back to the PECB client (step 780). The PECB client then renders the event data structures in the electronic calendar in accordance with the merged/consolidated event data structures and the prioritization of the event data structures relative to each other (step 790). The operation then terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system, for consolidating event data structures in an electronic calendar, the method comprising:
receiving an event data structure for an event from an event resource;
extracting features from the event data structure and at least one other event data structure having an overlapping temporal location in the electronic calendar;
executing at least one first machine learning computer model on the extracted features to classify the event data structure as to whether the event data structure is duplicative of the at least one other event data structure; and
rendering, in the electronic calendar, at least one consolidated event data structure corresponding to the event data structure and the at least one other event data structure based on the classification of the event data structure, wherein rendering the at least one consolidated event data structure comprises, in response to the classification indicating that the event data structure is duplicative of the at least one other event data structure, merging the event data structure with the at least one other event data structure to generate the at least one consolidated event data structure.

2. The method of claim 1, wherein rendering the at least one consolidated event data structure comprises, in response to the classification indicating that the event data structure is not duplicative of the at least one other event data structure, generating a relative priority scoring of the event data structure relative to the at least one other event data structure and rendering the at least one consolidated event data structure as a relative rendering of the event data structure and the at least one other event data structure that depicts the relative priority scores.

3. The method of claim 2, wherein generating a relative priority scoring of the event data structure comprises executing at least one second machine learning computer model on the extracted features to generate a priority score for the event data structure and the at least one other event data structure.

4. The method of claim 3, wherein the at least one second machine learning computer model comprises a second machine learning computer model that determines a purpose of the event data structure and a purpose of the at least one other event data structure based on the extracted features, and wherein the relative priority scores are based on the determined purpose of the event data structure and purpose of the at least one other event data structure.

5. The method of claim 1, further comprising:
retrieving a user profile for a user associated with the electronic calendar, wherein the user profile specifies one or more event resources, from a plurality of event resources, to consolidate and one or more types of event data structures to consolidate;
determining whether the event data structure for the event is from an event resource that matches the one or more event resources specified in the user profile;
in response to the event data structure being received from an event resource matching the one or more event resources, determining whether a type of the event data structure matches the one or more types of event data structures to consolidate as specified in the user profile; and
in response to the type of the event data structure matching the one or more types of event data structures to consolidate, performing the executing and rendering operations.

6. The method of claim 1, further comprising training, the at least one first machine learning computer model, on training data comprising existing samples of event data structures and ground truth classification of the existing samples, wherein the training comprises, for each sample in the training data:
processing the sample in the training data to generate a classification result specifying whether the sample represents duplicate event data structures or conflicting data structures;
comparing the classification result to the corresponding ground truth classification to determine a loss; and
modifying an operational parameter of the at least one first machine learning computer model based on the determined loss.

7. The method of claim 6, wherein the samples are captured instances of previous manual consolidations of event data structures by a user associated with the electronic calendar.

8. The method of claim 1, further comprising:
receiving a user input to a user interface associated with the electronic calendar, wherein the user input specifies an acceptance or rejection of the at least one consolidated event data structure; and
dynamically updating an operational parameter of the at least one first machine learning computer model based on the user input specifying acceptance or rejection of the at least one consolidated event data structure.

9. The method of claim 1, wherein the method is executed in response to receiving a user input to a human-computer interaction (HCI) environment of the data processing system, and executing natural language processing on the user input, where the natural language processing determines an intent of the user input as being associated with event consolidation.

10. The method of claim 9, wherein the HCI environment is a chatbot application and the user input is a natural language statement entered into the chatbot application, and wherein rendering at least one consolidated event data structure further comprising outputting a natural language response to the user input via the chatbot application.

11. The method of claim 1, wherein the extracted features comprise an event title, an event date, an event time, an event location, and event participants.

12. The method of claim 1, wherein merging the event data structure with the at least one other event data structure comprises executing consolidation strategy rules or algorithms that specify logic for combining event descriptions, merging participant lists, and updating event properties to accommodate the properties of the event data structure and the at least one other event data structure.

13. The method of claim 1, wherein merging the event data structure with the at least one other event data structure comprises executing consolidation strategy rules or algorithms that specify logic for resolving conflicting properties of the event data structure and the at least one other event data structure.

14. The method of claim 2, wherein generating the relative priority scoring of the event data structure comprises applying one or more user specified prioritization criteria specified in a user profile of a user associated with the electronic calendar.

15. The method of claim 14, wherein the one or more user specified prioritization criteria comprises at least one executable rule specifying a condition and a modification of a priority score of a corresponding event data structure in response to the condition being satisfied, and wherein the condition is based on event participant acceptance of an invitation associated with the corresponding event data structure.

16. The method of claim 1, wherein rendering the at least one consolidated event data structure further comprises generating a reminder or notification for the at least one consolidated event data structure based on reminder or notification settings associated with the event data structure and the at least one other event data structure.

17. A computer program product comprising a computer readable storage medium having a computer readable program stored therein, wherein the computer readable program, when executed on a computing device, causes the computing device to implement the method comprising:
receiving an event data structure for an event from an event resource;
extracting features from the event data structure and at least one other event data structure having an overlapping temporal location in the electronic calendar;
executing at least one first machine learning computer model on the extracted features to classify the event data structure as to whether the event data structure is duplicative of the at least one other event data structure; and
rendering, in the electronic calendar, at least one consolidated event data structure corresponding to the event data structure and the at least one other event data structure based on the classification of the event data structure, wherein rendering the at least one consolidated event data structure comprises, in response to the classification indicating that the event data structure is duplicative of the at least one other event data structure, merging the event data structure with the at least one other event data structure to generate the at least one consolidated event data structure.

18. The computer program product of claim 17, wherein rendering the at least one consolidated event data structure comprises, in response to the classification indicating that the event data structure is not duplicative of the at least one other event data structure, generating a relative priority scoring of the event data structure relative to the at least one other event data structure and rendering the at least one consolidated event data structure as a relative rendering of the event data structure and the at least one other event data structure that depicts the relative priority scores.

19. An apparatus comprising:
at least one processor; and
at least one memory coupled to the at least one processor, wherein the at least one memory comprises instructions which, when executed by the at least one processor, cause the at least one processor to implement the method comprising:
receiving an event data structure for an event from an event resource;
extracting features from the event data structure and at least one other event data structure having an overlapping temporal location in the electronic calendar;
executing at least one first machine learning computer model on the extracted features to classify the event data structure as to whether the event data structure is duplicative of the at least one other event data structure; and
rendering, in the electronic calendar, at least one consolidated event data structure corresponding to the event data structure and the at least one other event data structure based on the classification of the event data structure, wherein rendering the at least one consolidated event data structure comprises, in response to the classification indicating that the event data structure is duplicative of the at least one other event data structure, merging the event data structure with the at least one other event data structure to generate the at least one consolidated event data structure.

20. The apparatus of claim 19, wherein rendering the at least one consolidated event data structure comprises, in response to the classification indicating that the event data structure is not duplicative of the at least one other event data structure, generating a relative priority scoring of the event data structure relative to the at least one other event data structure and rendering the at least one consolidated event data structure as a relative rendering of the event data structure and the at least one other event data structure that depicts the relative priority scores.
